(19) United States
(12) Patent Application Publication
(10) Pub. No.: US 2023/0140009 A1
(43) Pub. Date: May 4, 2023

(54) PHOTOVOLTAIC MODULE, PHOTOVOLTAIC MODULE FASTENING SYSTEM, PHOTOVOLTAIC MODULE FASTENING METHOD

(71) Applicant: TOPICO LOCACOES DE GALPOES E EQUIPAMENTOS PARA INDUSTRIAS S.A., Embu das Artes (BR)

(72) Inventors: LEONARDO AUGUSTO DE CAMPOS, Sao Paulo (BR); ANTONIO CESAR GALHARDI, Jundiai (BR); FERNANDO DE MORAIS GOMES, Caieiras (BR)

(21) Appl. No.: 17/794,219

(22) PCT Filed: Jan. 19, 2021
(86) PCT No.: PCT/BR2021/050023

§ 371 Date: Jul. 20, 2022

(30) Foreign Application Priority Data
Jan. 21, 2020 (BR) 102020001274-6

(51) Int. Cl. H02S 20/22

(52) U.S. Cl. CPC H02S 20/22

(57) ABSTRACT

The present invention relates to a flexible infrastructure solution that enables the use of flexible photovoltaic panels customized to the requirements of the user, and with an assembly dynamic that enables a plurality of configurations. The solution comprises a plurality of photovoltaic modules that are fastened to flexible surfaces such as tarpaulins, a method for fastening said modules, and the structures that make up said modules.

### FIELD OF THE INVENTION

The present invention refers to a flexible infrastructure solution, which allows the use of flexible photovoltaic plates in a manner adequate to the user's needs, and with an assembly dynamic such that it allows a plurality of configurations.

The solution is made up of a plurality of photovoltaic modules that are fixed to flexible surfaces, such as canvases, to a method of fastening these modules and to the structures that comprise such modules.

### BACKGROUND OF THE INVENTION

In a globalized world in which technological advances and the increasingly demanding demands of consumers for products and services that meet the specificities of their application, organizations must continually reinvent themselves, including in processes. Factors such as sustainability, connectivity and sharing are key elements in the processes, in a scenario where resources are finite and sometimes scarce.

By investing in a flexible infrastructure, customers seek solutions that dynamically meet their needs and, in this context, many face restrictions in the availability of basic resources such as electricity and internet access because in some cases their facilities are located in places that are distant and, therefore, of infrastructure for such. Furthermore, the microgeneration of energy can bring complementary benefits to the demand for energy consumption and in an autonomous and sustainable way.

Currently there are microgeneration systems based on photovoltaic plates that are installed on roof structures of houses, buildings, sheds, among other surfaces, however, for flexible sheds that have polymer canvas covers, the metal structure is robust enough to support the load of rigid photovoltaic plates. Thus, the use of flexible photovoltaic plates (of less weight) is necessary and, therefore, the development of dynamic fastening means is required. In addition, in the flexible infrastructure model, it is assumed that the system must be assembled and disassembled numerous times during its lifetime.

Being a flexible structure, the sheds assume a multitude of configurations as they adapt to the specificities of each project/client.

Aspects related to plate maintenance become important because the client leases the shed and the power generation system and in that regard it was necessary to think of a system that would provide ease and agility in the assembly and disassembly of thereof in the canvas of sheds, trucks, among others.

The patent literature already has some suggestions to solve this problem, however, they differ from the present invention in several aspects.

Patent JP 5363925 discloses a structure for fastening solar batteries in tents to avoid problems due to differences in expansion coefficients. It proposes a solar battery completely covered with protective layers and glued to a reinforcing strip on its periphery that has holes for connection to the tent. The surface of the tent has a fastening sheet, which has part of its surface glued to the surface of the tent and the part that is not glued has holes that will allow connection to the solar battery by means of cables that join these two holes.

A problem with this approach is that the fastening sheet, as it is subjected to the tension of the connection with the solar battery at isolated points, is susceptible to wear that can compromise the integrity of the tent. The solution presented here uniformly distributes this tension and avoids this drawback of the state of the art.

Patent PT 2773826 describes a system for mounting a flexible photovoltaic plate on a stretched screen, intended to cover, at least partially, a right side of the referred stretched screen. The system further comprises an insert element comprising a textile layer and an adhesive layer. The system also comprises an air gap arranged between an active area of the flexible photovoltaic plate and the coated textile layer.

The present invention differs from this document in that it does not contain textile layers or air pockets.

Document WO 01/94719 describes flexible photovoltaic devices, which are lightweight, self-adhesive and can be easily attached to a variety of structures.

WO 01/94719 describes devices that are placed on surfaces and cannot be easily removed or transported. The present invention differs from the referred document by providing dynamics in the positioning and arrangement of the photovoltaic plates, while allowing their easy and rapid disassembly.

Therefore, the present invention is innovative compared to the current state of the art and even if a specialist were to combine these teachings, the solution proposed by this invention would not be achieved.

### SUMMARY OF THE INVENTION

The object of the present invention is a photovoltaic module comprising at least one flexible photovoltaic plate glued to a flexible membrane, wherein the flexible membrane comprises fastening means.

An additional object of the present invention is a photovoltaic plate fastening system comprising:
a) at least one photovoltaic module; and
b) a flexible support membrane comprising fastening means; where the fastening means of the photovoltaic module are able to be fixed to the fastening means of the flexible support membrane.

An additional object of the present invention is a photovoltaic plate cable protection method comprising the steps of:
a) providing a flexible support membrane comprising fastening means;
b) providing at least one photovoltaic module;
c) fastening the photovoltaic module on the flexible support membrane.

In a preferred embodiment, the flexible support membrane is part of the structure itself, such as the ceiling/roof of a tent or stand.

In another preferred embodiment, the flexible support membrane is placed on the roof of the structure, such as a shed. In this embodiment, the method comprises an additional step d):
d) positioning the flexible support membrane on the desired structure.

An additional object of the present invention is a structure comprising a flexible support membrane comprising at least one photovoltaic module.

### BRIEF DESCRIPTION OF THE FIGURES

FIG. 1A shows a three-dimensional view of the flexible membrane (main membrane) with the attached photovoltaic module (photovoltaic plate). FIG. 1B shows the detail of the zipper closure means.

FIG. 2A shows a three-dimensional view of the flexible membrane (main membrane) with the attached photovoltaic module (photovoltaic plate). FIG. 2B shows the detail of the loop fastening means.

FIG. 3A shows a three-dimensional view of the flexible membrane (main membrane) with the attached photovoltaic module (photovoltaic plate). FIG. 3B shows the detail of the zipper closure means.

FIG. 4A shows a three-dimensional view of the flexible membrane (main membrane) with the attached photovoltaic module (photovoltaic plate). FIG. 4B shows the detail of the velcro closure means.

### DETAILED DESCRIPTION OF THE INVENTION

The following description is intended only to exemplify some of the numerous ways of carrying out the invention, and should not be viewed as limiting the scope of the present invention.

Thus, understanding that the fastening of flexible photovoltaic plates on flexible canvases was a restrictive factor for their use and that this fastening needed to be easy to assemble and disassemble to meet the dynamic needs of the business, the solutions presented were then developed that provide the use of the plates and in a way that adheres to the needs of the sector.

When developing the solution, we identified that it solves the problem of fastening photovoltaic plates on flexible surfaces and that it provides ease of mounting and dismounting them as many times as necessary (that is, the fastening is not permanent as in the case of gluing the photovoltaic plate on the canvas, for example). Photovoltaic module

The photovoltaic module according to the present invention comprises at least one flexible photovoltaic plate glued to a flexible membrane, the flexible membrane comprising fastening means.

Any flexible photovoltaic board known in the art can be used and is within the scope of the present invention. Flexible membranes include, but are not limited to, a vinyl membrane. Other polymeric membranes can be used and are within the scope of the present invention.

Examples of suitable fastening means for use in the present invention include, but are not limited to, zippers, velcro, canvas straps with rope ties, nylon straps with adjustable straps, and combinations thereof. The photovoltaic modules comprise at least one type of fastening means. Photovoltaic plate fastening system

The photovoltaic plate fastening system of the present invention comprises:
a) at least one photovoltaic module; and
b) a flexible support membrane comprising fastening means; where the fastening means of the photovoltaic module are able to be fixed to the fastening means of the flexible support membrane.

The photovoltaic module is as defined above.

The flexible support membrane can be made of the same material as the flexible membrane of the photovoltaic module, or made of another material. Flexible membranes include, but are not limited to, a vinyl membrane. Other polymeric membranes can be used and are within the scope of the present invention.

Examples of suitable fastening means for use in the present invention include, but are not limited to, zippers, velcro, canvas straps with rope ties, nylon straps with adjustable straps, and combinations thereof. The flexible support membrane comprises at least one type of fastening means.

### Method of Fastening Photovoltaic Plates.

The photovoltaic plate cable fastening method according to the present invention comprises the steps of:
a) providing a flexible support membrane comprising fastening means;
b) providing at least one photovoltaic module;
c) fastening the photovoltaic module on the flexible support membrane;
d) optionally, positioning the flexible support membrane on the desired structure.

In a preferred embodiment, the method comprises a plurality of photovoltaic modules. In addition, the flexible support membrane can be attached to the desired structure with any suitable fastening means, including the fastening means described herein.

The choice of the appropriate fastening means depends on the application to be used (a short- or long-term application) and also on the climatic conditions that may act on the module, such as winds and/or rain.

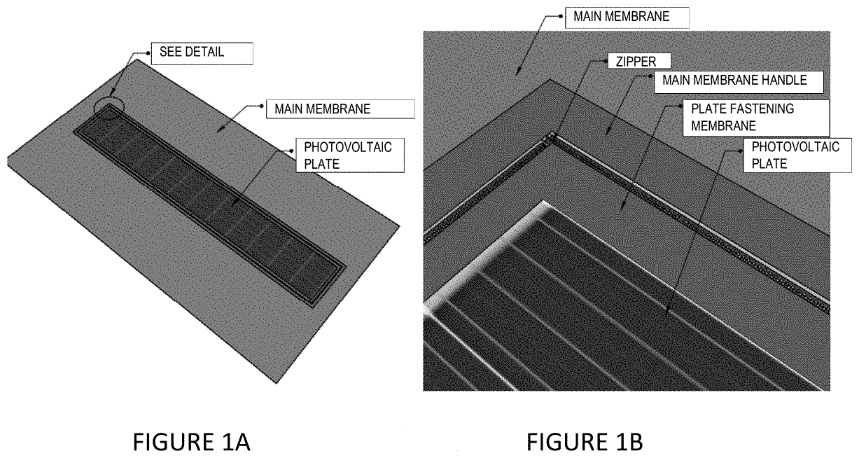

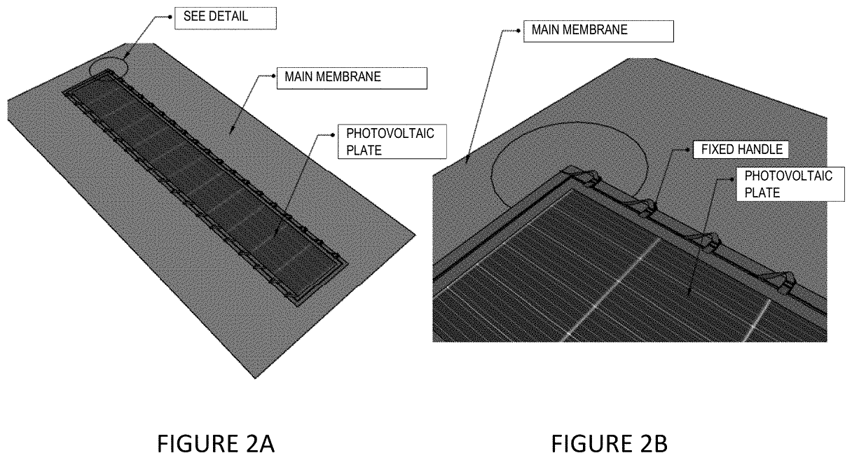

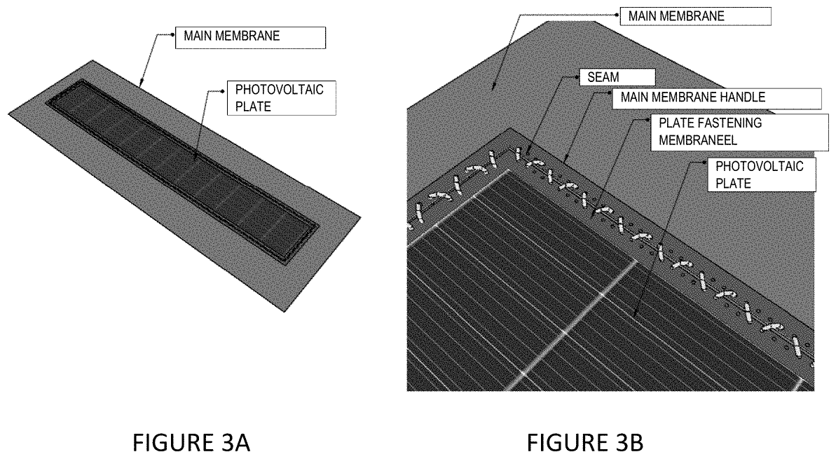

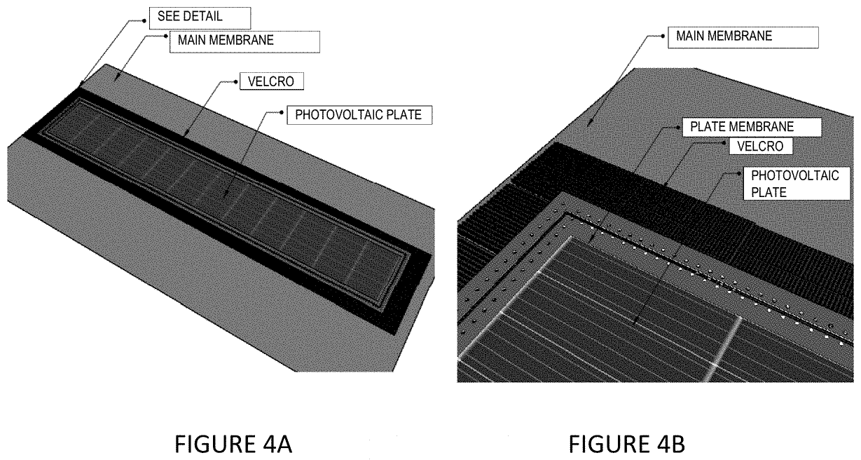

FIGS. 1-4 show details of the flexible membranes and fastening means presented here.

### EXAMPLE

The photovoltaic plate is glued on a vinyl membrane (canvas) that contains a fastening ring.

On the roof membrane of our sheds are welded flaps that contain nylon tapes. The plates are fixed by connecting the strips of the nylon membrane to the tabs that are welded to the roof by the rings on the membrane where the photovoltaic plate is attached. This solution solves the problem of mounting and dismounting the plates for maintenance, cleaning and other needs, as well as allowing this to happen quickly (productivity).

1. Photovoltaic module characterized in that it comprises at least one flexible photovoltaic plate attached to a flexible membrane, where the flexible membrane comprises fastening means.

2. Photovoltaic module, according to claim 1, characterized in that the flexible membrane is a vinyl canvas.

3. Photovoltaic module, according to claim 1 or 2, characterized in that the fastening means are chosen from the group comprising zipper, velcro, canvas straps with cords, adjustable nylon straps, stitching, and combinations thereof.

4. Photovoltaic plate fastening system characterized by comprising:
a) at least one photovoltaic module as defined in claims 1-3; and
b) a flexible support membrane comprising fastening means; where the fastening means of the photovoltaic module are adequate to be fixed to the fastening means of the flexible support membrane.

5. Fastening system, according to claim 4, characterized in that the flexible support membrane is a vinyl canvas.

6. Photovoltaic module, according to claim 4 or 5, characterized in that the fastening means are chosen from the group comprising zipper, velcro, canvas straps with cords, adjustable nylon straps, stitching, and combinations thereof.

7. Photovoltaic plate fastening method characterized by comprising the steps of:
a) providing a flexible support membrane comprising fastening means;
b) providing at least one photovoltaic module as defined in claims 1-3;
c) fastening the photovoltaic module on the flexible support membrane;
d) positioning the flexible support membrane on the desired structure.

8. Method, according to claim 7, characterized in that the flexible support membrane is a vinyl canvas.

9. Method, according to claim 7 or 8, characterized in that the fastening means are chosen from the group comprising zipper, velcro, canvas straps with cords, nylon straps with adjustable, sewn, and combinations thereof.

10. Method according to any of claims 7 to 9, characterized in that step d) comprises fastening the flexible support membrane on the structure by means of a fastening chosen from the group comprising zipper, velcro, canvas straps with cords, nylon with adjustable seams, and combinations thereof.
